(19) United States
(12) Patent Application Publication
(10) Pub. No.: US 2022/0205302 A1
(43) Pub. Date: Jun. 30, 2022

(54) CONTROLLER FOR DOOR OR WINDOW DRIVE

(71) Applicant: Gotthard 3 Mechatronic Solutions AG, Muri (CH)

(72) Inventor: Stefan Schimon, Hämikon (CH)

(21) Appl. No.: 17/610,799

(22) PCT Filed: May 15, 2020
(86) PCT No.: PCT/EP2020/063667

§ 371 Date: Nov. 12, 2021

(30) Foreign Application Priority Data
May 15, 2019 (CH) 00635/19

(51) Int. Cl. E05F 15/611; E05F 15/70

(52) U.S. Cl. CPC E05F 15/611; E05F 15/70; E05Y 2900/148; E05Y 2900/132; E05Y 2201/434; E05Y 2400/562; E05Y 2400/337

(57) ABSTRACT

The invention concerns a method for controlling a drive (5) for a leaf (1), in particular for a door leaf or a window leaf, including the following steps: Measuring a measured value (vr) of a kinetic quantity of the leaf (1), comparing the measured value (vr) with a tolerance range (TB) of a reference travel curve (SFK), driving the leaf (1) by the drive (5) according to the reference travel curve (SFK). Upon the measured value (vr) leaving the tolerance range (TB), the leaf (1) is set to a freewheel (FL) in which the drive (5) is suspended.

### CROSS-REFERENCE TO RELATED APPLICATIONS

This application is a National Stage application of International Patent Application No. PCT/EP2020/063667, filed on May 15, 2020, which claims priority to Swiss Patent Application No. 00635/19 filed on May 15, 2019, each of which is hereby incorporated by reference in its entirety.

### TECHNICAL FIELD

The invention relates to a method of controlling a drive for a leaf, in particular for a door leaf or a window leaf.

### BACKGROUND

It is known to operate a door or window automatically with a drive, e.g. an electric motor. This means that a user does not have to apply a force himself to open or close the door or window. Corresponding automatic drives comprise a control for the drive, which is triggered by the user, for example by pressing a door handle or a window handle or as well by approaching a proximity sensor. The control then initiates a predetermined movement of the door or window. When the door or window is in an open or closed position, the drive does not normally exert any force on the door or window.

Conventional drives have several disadvantages. If the user applies an external force to the door or window while the drive is controlling it, the drive will work against the external force. On the one hand, this is inconvenient for the user and undesirable, since the user may want to quickly reopen or close the door or window against the drive or hold it in a central position. On the other hand, such behaviour of the drive may lead to damage of a drive mechanism.

### SUMMARY

The present invention relates to the problem of eliminating the disadvantages of conventional drives for doors or windows. This problem is solved by a method for controlling a drive according to claim 1 and by the automatic drive according to claim 13.

For the sake of clarity, it is appropriate to define at the outset certain terms which, in the present application, have a specific meaning over and above their normal meaning.

Leaf: In the following, the movable part of a door, window or similar device is referred to as leaf, also called door or window leaf. For example, in addition to the door leaf, a door frame, also called a door casing, also belongs to a door. In this context, the term leaf in the sense of the invention is not limited to rotatably mounted leaves, but also includes leaves which are slid to open or close, and other conceivable embodiments.

Kinetic quantity: In the following, a kinetic quantity is a physical quantity that is indicative of a movement of the leaf. In particular, the kinetic quantity may be a position or a velocity, the latter being the first derivative of the position with respect to time. Further time derivatives of the position are also conceivable as kinetic quantities. In the case of a rotatably mounted leaf, e.g. in the case of a conventional swing door, the kinetic quantity may be an angular position or an angular velocity, respectively.

Reference travel curve: In the following, reference travel curve means a relation between a first kinetic quantity and a second kinetic quantity, e.g. between velocity and position, or between a kinetic quantity and time, e.g. between position and time. The course of the reference travel curve or at least certain parameters or criteria for the reference travel curve are predetermined. The reference travel curve may, for example, be stored as a curve, function or look-up table. As a rule, a drive drives the leaf, whereby the kinetic quantity is controlled according to reference values in accordance with the reference travel curve, e.g. a velocity control depending on the position of the leaf.

Tolerance range: In the following, the term tolerance range refers to a range of values of the kinetic quantity above and/or below the reference values according to the reference travel curve. The tolerance range is limited in particular by a lower tolerance value and an upper tolerance value. The lower tolerance value is smaller than the reference value, and the upper tolerance value is larger than the reference value. The lower and/or the upper tolerance value can be variable, for example depending on the position of the leaf. Leaving the tolerance range means that measured values of the kinetic quantity fall below the lower tolerance value in the downward direction or exceed the upper tolerance value in the upward direction. In particular, the drive of the leaf is dimensioned in such a way that it can control the kinetic quantity of the leaf without leaving the tolerance range when only omnipresent forces such as gravity and frictional forces act on the leaf.

Measurement: In the following, measuring a quantity, in addition to the direct measurement of a physical quantity, refers to the derivation of further quantities from the directly measured quantity. For example, the angular position of a leaf can be determined by an encoder or rotary encoder via a voltage or a number of voltage pulses. In this case, however, measuring may also include the determination of the angular velocity from the angular position, in particular by taking a derivative with respect to time.

Freewheel: Usually the drive is controlled by a control unit, wherein a voltage is applied to the drive, the value of which is determined by the control unit. In freewheel mode, however, the drive is suspended. Advantageously, no voltage is applied to the drive in freewheel. Thus, in freewheel, advantageously only a force acts on the leaf which is smaller than a minimum force. This force may, for example, originate from friction, for example in a door bearing or in the drive, or from a generator effect which occurs, for example, when the drive is short-circuited, or from any springs present in the drive. The minimum force is in particular 67 N. This value comes from the EN 16005 standard for power-operated doors and gives a maximum value of how hard a user must push on the leaf when the drive is suspended. The freewheel thus defined hence is in contrast with the driven state of the leaf. In particular, a leaf in freewheel mode moves as normally expected by the user, since only omnipresent forces such as gravity and frictional forces act on the leaf.

One aspect of the invention is a method for controlling a drive for a leaf, in particular for a door leaf or a window leaf, comprising the following steps: Measuring a measured value of a kinetic quantity of the leaf, comparing the measured value with a tolerance range of a reference travel curve, and driving the leaf by the drive according to the reference travel curve. If the measured value leaves the tolerance range, the leaf is set into a freewheel, in which the drive stops. If the measured value is within the tolerance range, however, the leaf is advantageously driven by the drive. Furthermore, the measured value is advantageously also compared with a reference value according to the reference travel curve. If the measured value is within the tolerance range, the control unit advantageously regulates the drive in such a way that the kinetic quantity approaches the reference value.

The method thus controls, via the drive, in particular the kinetic quantity, namely e.g. the position and/or the velocity, of the leaf on the basis of the measured value and the specified reference travel curve. An advantage of the method is the freewheel mode, which starts under defined criteria. For example, the leaving of the tolerance range can be caused by a user or also an object that wants to open or close the leaf as quickly as possible or also stop in a middle position that corresponds neither to the closed nor to the fully open position. In freewheel, the control described allows the user to do this without having the drive work against him. On the one hand, this leads to a pleasant behaviour of the leaf which is perceived as natural and expected by the user. Thus, injuries caused by unexpected behaviour of a leaf, e.g. a heavy door, can be prevented. On the other hand, the behaviour protects a mechanical system and any gear and linkage parts of the drive.

In the following, further advantageous criteria and parameters are described which can be prescribed for the control of the leaf and further increase a user-friendliness of an automatic drive with such control. For example, after a period of time defined for the freewheel, the driving of the leaf according to the reference travel curve advantageously starts again. The defined time period can be, for example, between 1 s and 60 s, and in particular between 2 s and 10 s. As a result, the leaf is advantageously brought into a defined position by the drive after the time period defined for freewheeling, which in particular may be a closed or an open position of the leaf. The aforementioned specifications for the control have the advantage that the leaf does not remain permanently in the freewheeling state, which represents an uncontrolled state. The user who approaches the leaf after the defined period of time and a subsequent opening or closing operation will find it in an expected state, whether closed or open. Thus, the user does not have to worry about a complete opening or closing of the leaf, but can save time and leave the leaf in any position without the leaf remaining in particular in an unsecured position and slamming uncontrolled, for example.

Advantageously, the reference travel curve comprises the following sections: Accelerating the leaf from a rest velocity, which is in particular zero, in a zero position to a first velocity at a first position; Moving the leaf at the first velocity to a second position; Decelerating the leaf from the first velocity to the rest velocity so that it has the rest velocity when it reaches a third position. The reference travel curve may describe one of the following operations: an opening operation of the leaf, wherein the zero position is a closed position of the leaf and the third position is an open position of the leaf, in particular in the stop; or a closing operation of the leaf, wherein the zero position is an open position of the leaf and the third position is a closed position of the leaf. Advantageously, the rest velocity in the zero position and the third position is zero. This ensures that the drive does not forcefully slam the leaf, which could result in damage to the leaf, frame or drive. Furthermore, noise emissions and injuries to the user can be prevented.

However, the case may arise that a user or an object, e.g. a hospital bed, or some other external force, e.g. a draught, has accelerated the leaf to such an extent that it is no longer possible to decelerate to the rest velocity before the third position is reached. In order to avoid this, a further criterion may be established for the control: Advantageously, the freewheel of the leaf is terminated and the leaf is driven by the drive when the measured value of the kinetic quantity is above a maximum value. In particular, the maximum value depends on a maximum braking force of the drive and the position of the leaf. The maximum braking force of the drive can be determined in advance and stored as a parameter for the control. The maximum value that can just be braked by the drive, for example a maximum brakable velocity, is lower the closer the leaf is to the third position. It is in particular envisaged that the drive brakes the leaf with the maximum braking force after the end of freewheeling, so that it has the rest velocity when it reaches the third position.

In a further advantageous embodiment of the method, upon the leaf leaving the tolerance range—i.e. in particular when it would actually go into freewheeling—it is first braked or accelerated with a defined acceleration value in the direction of the reference value as an option before it goes into freewheeling. A defined acceleration value is particularly suitable if a defined force is applied to the leaf over a defined period of time, e.g. during 1 s. Instead of the leaf going into freewheeling, driving is advantageously resumed according to the reference travel curve when the kinetic quantity changes according to the defined acceleration value. Otherwise, the leaf is actually set to freewheel. Whether the kinetic quantity changes according to the defined acceleration value can be determined by recording a time series of measured values of the kinetic quantity and comparing them with a time series expected on the basis of motion equations. The added benefit of “braking” or “briefly accelerating” when the leaf is freewheeling is that it makes it easier to distinguish between a volitional force by a user and some other force, such as a momentary breeze, on the leaf. Only in the case of a sustained external force, e.g. by a user or an object, should the leaf advantageously go into freewheeling.

Furthermore, it may be defined how the drive of the leaf can be activated, in particular by a user: Advantageously, the driving of the leaf by the drive according to the reference travel curve is triggered by an opening or closing command. This may comprise one of the following events: an actuation of a switch or button, in particular a pressing of a door handle or a window handle; or a signal from a device in communication with the drive, for example a third-party system or a mobile device connected to the drive wirelessly or by cable; or a signal from a sensor in communication with the drive; or an action of a force on the leaf from externally, exerted in particular by a person or by an object, for example a hospital bed. A resuming of the control after application of an external force is also referred to as “push & go”. The user only has to push the leaf for a short time so that the drive starts; subsequently, due to the described control, he can simply continue walking without worrying about the position in which the leaf remains. In an advantageous embodiment, the opening or closing command also terminates the freewheeling of the leaf. Thus, this represents another criterion for how the leaf can move from freewheeling to the driven state—in addition to the possible criteria of defined time duration and maximum braking force.

Another aspect of the invention relates to an automatic drive for a leaf, in particular for a door leaf or a window leaf. The automatic drive comprises a sensor configured to measure a kinetic quantity of the leaf, a drive and a control unit configured to carry out the method described above. For measuring the kinetic quantity, an encoder, also called a rotation encoder, can be used in particular, or an electrical resistance which can be varied via the position of the leaf. However, other measuring principles and sensors are also conceivable, for example capacitive measuring. The drive can be designed in particular as an electric motor or as an actuator. In an advantageous embodiment, the automatic drive further comprises a sensor configured to measure a drive voltage. From the drive voltage, further parameters usable for the control unit can be derived, for example a power or a force that the drive absorbs or must exert in order to achieve a certain value of the kinetic quantity, in particular when an external force is working against the drive. In another advantageous embodiment, the drive comprises a braking device for braking the leaf. The braking device may effect braking of the leaf in addition to a braking force exerted by the electric motor or the actuator. One embodiment of the braking device is a blocker in a gear or linkage of the drive.

Another aspect of the invention relates to a computer program which, when executed on a processor, causes the method described to be carried out. For implementation, the computer program may be stored on a computer readable medium.

It is apparent to one skilled in the art that synergistic effects may result from combining features of various embodiments and aspects. Although these are not described in detail, they are expressly included in the disclosure of the present document.

### BRIEF DESCRIPTION OF THE DRAWINGS

Further advantageous embodiments of the invention will be apparent from the embodiments illustrated below with reference to the figures. They show:

FIG. 1 a perspective view of a door including drive, control and various sensors and switches according to an embodiment;

FIG. 2 a diagram of a reference travel curve with reference values of a kinetic quantity and a tolerance range according to an embodiment;

FIG. 3 a flow diagram of a method for controlling a drive for a leaf, in particular for a door leaf or window leaf, according to an embodiment;

FIG. 4 a flow diagram of an alternative method for controlling a drive for a leaf, in particular for a door leaf or window leaf, according to an embodiment.

### DETAILED DESCRIPTION

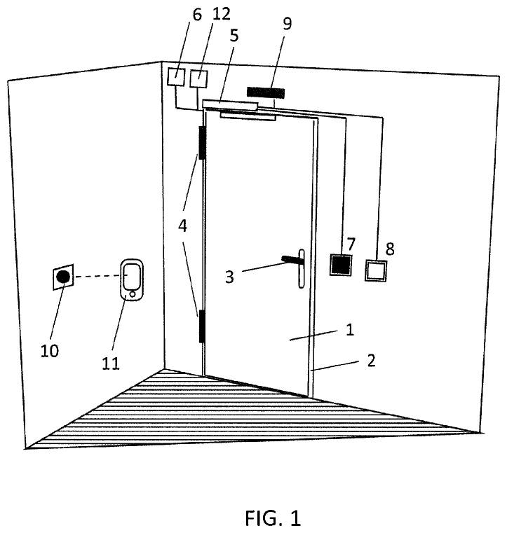

FIG. 1 shows a perspective view of a door in a room according to an embodiment. The door comprises a door leaf 1, a door frame 2 and a door handle 3 for manually opening and closing the door. The embodiment of FIG. 1 shows a swing door, in which the door leaf 1 is rotatably mounted on the door frame 2 at its left side via door hinges 4. However, the devices and methods described below are not limited to swing doors, but can also be applied to other leaves, e.g. window leaves, and to other types of mounting, e.g. sliding doors or sliding windows.

According to the invention, the door leaf 1 may be driven by a drive 5. Frequently, the drive 5 is an electric motor or an actuator mounted on the door lintel above the door frame 2 and connected to the door leaf 1 via a linkage. Alternatively, however, the drive 5 may be attached to the door leaf 1. The drive 5 is controlled by a control unit, which may be integrated in a housing of the drive 5 or may be external. The necessary power for the drive 5 and control is provided by a power supply 6.

The control of the drive 5 can be triggered or switched via various paths, some of which are shown in FIG. 1. For triggering or switching the control unit, a signal via one of the paths is sufficient. On the one hand, the door handle 3 may be connected to the control unit, for example via an electrical connection or via radio connection, so that a manual opening or closing command is communicated to the control unit by actuating the door handle 3. However, various other types of pulse generator are also possible, such as a switch 7 or a pushbutton 8, in particular also a switch which can be actuated with a key or a fingerprint. Furthermore, a closing or opening command can be triggered by a proximity sensor 9 when a user approaches the door.

Advantageously, there is also a radio switch 10 which is triggered when approached, for example, by a token or a mobile phone 11 carried by the user. The user can thus easily open the door and pass through without having to be hands-free. In particular, triggering the control by a mobile phone 11 is advantageous, since not only an opening or closing command can be forwarded via a radio connection, for example via Bluetooth, from the mobile phone 11 to the radio switch 10 or directly to the control, but further functionalities may be facilitated. For example, various parameters of the control unit can be set via an app, for example a maximum opening angle, an opening or closing velocity or a predefined time period for a freewheel. A calibration of the drive 5 can also be carried out in this way.

Furthermore, the closing or opening command may also come from a third-party system 12 that is connected to the drive 5 or its control system. An example of such a third-party system 12 is a fire alarm system that triggers the closing of all doors to prevent a fire to extend. In another embodiment, the closing or opening command may be triggered by a signal from a sensor communicating with the drive 5 or its control system.

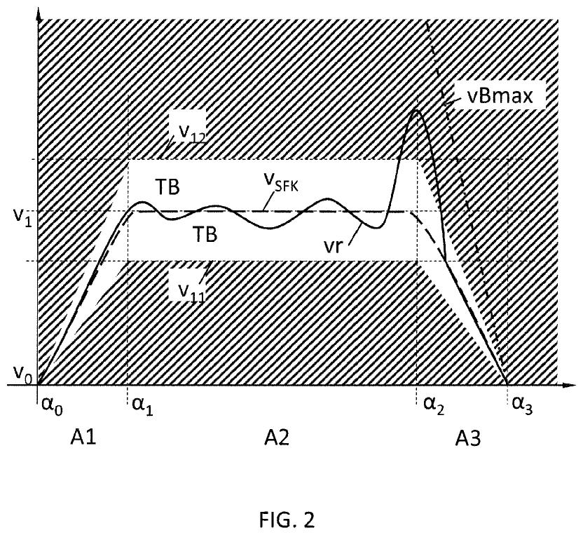

FIG. 2 shows a diagram of a reference travel curve SFK, which specifies reference values of a kinetic quantity to which the control system controls the door leaf 1. In the case shown, the controlled kinetic quantity is a velocity v as a function of an angular position α. Such a control system can be used, for example, for the swing door of FIG. 1. At the angular position α0, also called zero position, the door leaf 1 is in closed position, α3 denotes a third angular position for which it is useful to preset the angular position at the stop of the door leaf 1 or any other value between closed position and stop.

With the reference travel curve SFK shown in FIG. 2, the drive is controlled by the control system as a function of the angular position α, which is known from a measurement, e.g. with an encoder. A typical opening process of the door leaf can thus be divided into the following sections, which can also be applied analogously for a closing process:

When the control unit receives an opening command, the drive 5 accelerates the door leaf 1 in a first angular range A1 between the zero position α0 and a first angular position α1 from a rest velocity v0, which is zero, to a first velocity v1. In a second angular range A2 between α1 and a second angular position α2, the door leaf 1 is moved at the first velocity v1. In a third angular range A3 between α2 and α3, the door leaf 1 is decelerated by the drive 5 so that it reaches the rest velocity v0 again at the third angular position α3. Accordingly, the door is opened gently, whereby no further external action is required apart from an opening command.

There is a tolerance range TB around the reference travel curve SFK. Under normal circumstances, in particular in the absence of an external impact, the drive 5 is able to control the velocity v of the door leaf 1 within the tolerance range TB. At the same time, the door leaf 1 is driven by the drive 5 as long as measured velocity values vr are within the tolerance range TB. In the example of FIG. 2, the tolerance range TB in the second angular range A2 is limited downwards by the lower tolerance value v11 and upwards by the upper tolerance value v12, where 0<v11<v1 and v12>v1.

If an external force is applied to the door leaf 1, for example by a user or a draught, the door leaf 1 may be slowed down or accelerated to such an extent that it leaves the tolerance range TB, so that vr<v11 or vr>v12. In the case of a user intentionally decelerating or accelerating the door, it is reasonable that the drive 5 does not continue to operate against the user. Therefore, when the door leaf 1 leaves the tolerance range TB, it enters a freewheel FL at which the drive 5 stops, and in particular at which the drive 5 is de-energized. In freewheeling FL, advantageously at most a minimum force of, for example, 67 N acts on the door leaf 1. In freewheeling FL, the user has the possibility of moving the door leaf 1 and, in particular, also braking it, as he is accustomed to doing with a drive-free door.

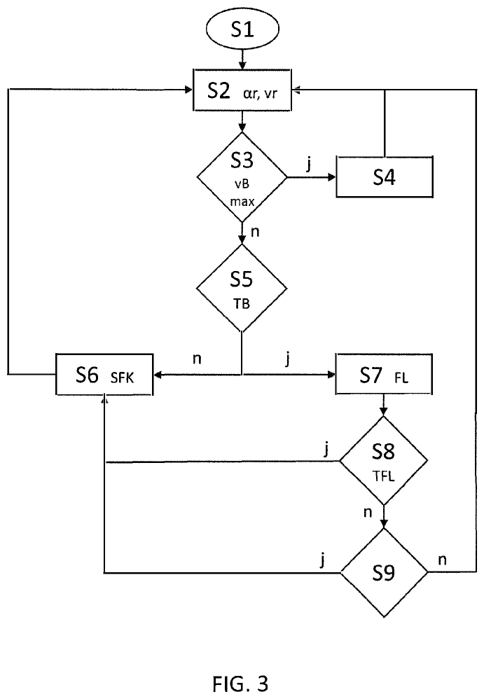

Various criteria are conceivable in order to return from freewheeling FL to the driven state of door leaf 1 according to the reference travel curve SFK. The criteria can be implemented individually or together. However, in order to return to the driven state, it is advantageously sufficient to satisfy one of the criteria: The drive 5 may control the velocity v of the door leaf again according to the reference travel curve SFK as soon as the measured velocity values vr are again within the tolerance range TB. Two other criteria are also advantageous: On the one hand, a defined time period TFL is specified for the freewheel FL, after which the control by the drive 5 is automatically resumed according to the reference travel curve SFK. On the other hand, a user may trigger a return to the driven state by a renewed opening or closing command. For this purpose, also an external force impact acting on the door leaf 1 is interpreted as an opening or closing command if it causes a certain acceleration of the door leaf 1 from the rest velocity v0. Such functionality is called “push & go”. The procedure for controlling the drive 5 and an interaction of the various criteria are further illustrated in FIG. 3.

FIG. 3 shows a flow diagram of a method for controlling a drive for a leaf, in particular for a door leaf, e.g. according to FIG. 1, or a window leaf according to an embodiment. The method shown comprises the steps S1 to S9. A control process is initiated by an opening or closing command in step S1. In step S2, a sensor, e.g. an encoder, is used to measure the instantaneous angular position αr and the instantaneous velocity vr. Step S3 represents a safety criterion: The drive 5 may brake the door leaf 1 at most with a maximum braking force FBmax, which is determined for the drive 5 and can be regarded as a fixed parameter for the door leaf 1. If the door leaf 1, according to the measurement, is already very close to the third angular position α3, i.e., for example, the stop, but continues to move at a velocity vr which is equal to or higher than a maximum brakable velocity vBmax, i.e., vr≥vBmax, then the drive 5 brakes the door leaf 1 immediately in step S4 with the maximum braking force FBmax in order to reach, if possible, the resting velocity v0 at α3 and to avoid an uncontrolled closing of the door leaf 1. Besides the parameter FBmax, the maximum brakable velocity vBmax also depends on the angular position αr or the angular distance to the maximum angular position, namely |α3−αr|. Furthermore, step S3 may comprise further safety criteria, e.g. commands from safety sensors or external safety systems such as a fire alarm system.

If the maximum brakable velocity vBmax is not exceeded, a comparison of the measured velocity vr with the velocities according to the tolerance range TB is carried out in step S5. If vr is within the tolerance range TB, the door leaf 1 is driven in step S6 by the drive 5 according to the reference travel curve SFK. This procedure is continued by measuring αr and vr again in step S2.

If, however, vr is outside the tolerance range TB, the door leaf 1 enters the freewheel FL in step S7, in which the drive 5 is suspended. The criteria for exiting the freewheel FL again have already been briefly mentioned in connection with FIG. 2: In step S8, a check is made as to whether the time that has elapsed since entry into the freewheel FL is greater than a predefined time period TFL. If yes, a change is made to the driven state according to step S6. If no, i.e. if the predefined time period TFL of e.g. 6 s has not yet elapsed, freewheeling FL is continued.

Furthermore, freewheeling FL can also be terminated according to step S9 if the control unit receives a renewed opening or closing command. In this case, the drive of door leaf 1 is continued according to the reference travel curve SFK in step S6. If no new opening or closing command is received, the sequence is continued with the measurement of αr and vr in step S2.

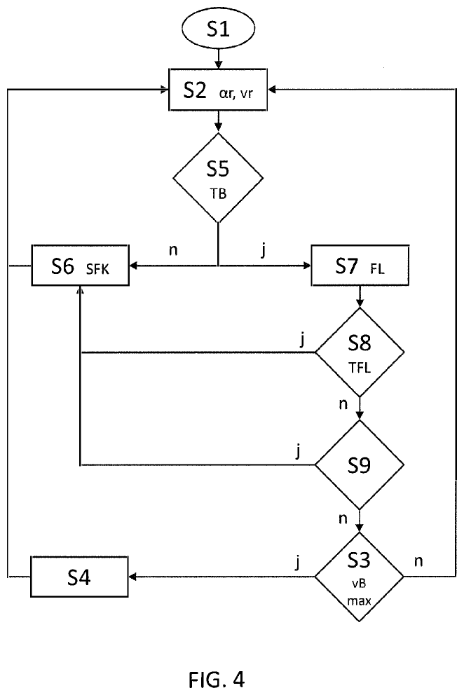

FIG. 4 shows a flow diagram of an alternative method for controlling a drive for a leaf, in particular for a door leaf, e.g. according to FIG. 1, or a window leaf according to an embodiment. As in FIG. 3, the method comprises steps S1 to S9. However, the order of the steps is changed in one essential point. For example, the criterion in S3 that the door leaf 1 is immediately braked with the maximum braking force FBmax when the maximum brakable velocity vBmax according to S4 is exceeded, has been moved to the end of the flow diagram. After measuring the kinetic quantities αr and vr in S2, the process therefore continues directly with S5, i.e. a decision is made as to whether the measured velocity vr lies within the tolerance range TB.

The maximum force criterion and any further safety criteria according to S3 only come into play in FIG. 4 if no further opening or closing command is detected in step S9. If the measured velocity vr in S3 does not exceed the maximum brakable velocity, the process steps from the measurement of the kinetic quantities αr and vr in S2 are performed again. In contrast to FIG. 3, in FIG. 4 the maximum force criterion is thus only checked when the door leaf 1 is in freewheeling FL.

FIGS. 3 and 4 thus show examples of embodiments of a method for controlling a drive for a door or window leaf. A different sequence of steps is also conceivable. For example, steps S8 and S9, which represent criteria for leaving the freewheel FL, can also be performed in reverse order.

Advantageously, the described method for controlling a drive for a door or window leaf is computer-implemented, for example on a microprocessor with corresponding memory, which manages the control of the drive 5.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A method for controlling a drive for a leaf, in particular for a door leaf or a window leaf, comprising the following steps:
measuring a measured value of a kinetic quantity of the leaf,
comparing the measured value with a tolerance range of a reference travel curve,
driving the leaf by the drive according to the reference travel curve,
wherein, upon the measured value leaving the tolerance range, the leaf is set into a freewheel in which the drive is suspended.

2. The method according to claim 1,
wherein, upon leaving the tolerance range, a force smaller than a minimum force acts on the leaf, in particular where the minimum force is 67 N.

3. The method according to claim 1,
wherein, in the case of a measured value within the tolerance range, the leaf is driven by the drive.

4. The method according to claim 1, wherein the tolerance range is limited by a lower tolerance value and an upper tolerance value, wherein the lower tolerance value is smaller than a reference value according to the reference travel curve, and
wherein the upper tolerance value is greater than the reference value, in particular wherein the lower and/or the upper tolerance value are variable, in particular wherein leaving the tolerance range means that the measured value falls below the lower tolerance value in the downward direction or exceeds the upper tolerance value in the upward direction.

5. The method according to claim 1, wherein the kinetic quantity is a position or a velocity, in particular an angular position or an angular velocity.

6. The method according to claim 1, wherein, after a time period defined for the freewheel, the driving of the leaf by the drive starts again according to the reference travel curve, in particular wherein the defined time period is between 2 s and 10 s.

7. The method according to claim 1, wherein the reference travel curve comprises the following sections:
accelerating the leaf from a rest velocity at a zero position to a first velocity at a first position,
moving the leaf at the first velocity to a second position,
decelerating the leaf from the first velocity to the rest velocity so that it exhibits the rest velocity when reaching a third position.

8. The method according to claim 7,
wherein the reference travel curve (SFK) is indicative of one of the following operations:
an opening operation of the leaf, wherein the zero position is a closed position of the leaf, and the third position is an open position of the leaf, or
a closing operation of the leaf, wherein the zero position is an open position of the leaf, and the third position is a closed position of the leaf.

9. The method according to claim 1, wherein the freewheel of the leaf is terminated and the leaf is driven by the drive when the measured value is above a maximum value which is dependent, in particular, on a maximum braking force of the drive and the position of the leaf, in particular wherein the drive brakes the leaf after termination of the freewheel with the maximum braking force so that it has the rest velocity when reaching the third position.

10. The method according to claim 1, wherein, upon leaving the tolerance range and before going into freewheel, the leaf is braked or accelerated with a defined acceleration value in the direction of the reference value, and the driving is resumed in accordance with the reference travel curve without the leaf entering the freewheel if the kinetic quantity changes in accordance with the defined acceleration value.

11. The method according to claim 1, wherein the driving of the leaf by the drive according to the reference travel curve is triggered by an opening or closing command comprising one of the following events:
an actuation of a switch or button, in particular a pressing of a door handle or a window handle, or
a signal from a device in communication with the drive, in particular from a third-party system or from a smartphone, or
a signal from a sensor in communication with the drive, or
an action of a force on the leaf from outside, exerted in particular by a person or an object.

12. The method according to claim 11 wherein the opening or closing command terminates the freewheel of the leaf.

13. An automatic drive for a leaf, in particular for a door leaf or a window leaf, comprising
a sensor configured to measure a kinetic quantity of the leaf, in particular an encoder,
a drive, in particular an electric motor or an actuator, and
a control unit configured to carry out the method according to any one of the preceding claims.

14. The automatic drive for a leaf according to claim 13, further comprising one or more of the following features:
a sensor configured to measure a drive voltage,
a braking device configured to brake the leaf.

15. A computer program comprising code means for performing a method according to claim 1 when executed on a processor.

16. The method according to claim 2, wherein the tolerance range is limited by a lower tolerance value and an upper tolerance value, wherein the lower tolerance value is smaller than a reference value according to the reference travel curve, and wherein the upper tolerance value is greater than the reference value, in particular wherein the lower and/or the upper tolerance value are variable, in particular wherein leaving the tolerance range means that the measured value falls below the lower tolerance value in the downward direction or exceeds the upper tolerance value in the upward direction.

17. The method according to claim 3, wherein the tolerance range is limited by a lower tolerance value and an upper tolerance value, wherein the lower tolerance value is smaller than a reference value according to the reference travel curve, and wherein the upper tolerance value is greater than the reference value, in particular wherein the lower and/or the upper tolerance value are variable, in particular wherein leaving the tolerance range means that the measured value falls below the lower tolerance value in the downward direction or exceeds the upper tolerance value in the upward direction.

18. The method according to claim 2, wherein the kinetic quantity is a position or a velocity, in particular an angular position or an angular velocity.

19. The method according to claim 3, wherein the kinetic quantity is a position or a velocity, in particular an angular position or an angular velocity.

20. The method according to claim 4, wherein the kinetic quantity is a position or a velocity, in particular an angular position or an angular velocity.
